(19) United States
(12) Patent Application Publication
(10) Pub. No.: US 2026/0012690 A1
(43) Pub. Date: Jan. 8, 2026

(54) METHOD FOR GENERATING LIVING STREAMING SCRIPT, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Tian WU, Beijing (CN); Dai DAI, Beijing (CN); Wenquan WU, Beijing (CN); Hao TIAN, Beijing (CN); Hua WU, Beijing (CN); Simei LIU, Beijing (CN); Hongyang ZHANG, Beijing (CN); Senbo KANG, Beijing (CN); Huan ZHANG, Beijing (CN); Junmei HAO, Beijing (CN); Ruijie WANG, Beijing (CN); Zhenyu JIAO, Beijing (CN); Han ZHOU, Beijing (CN); Zeyuan WANG, Beijing (CN); Zihe ZHU, Beijing (CN); Jie GONG, Beijing (CN); Zhanyu MA, Beijing (CN); Zhilong GUO, Beijing (CN); Dou HONG, Beijing (CN); Haifeng WANG, Beijing (CN)

(21) Appl. No.: 19/329,665

(22) Filed: Sep. 16, 2025

(30) Foreign Application Priority Data
Apr. 25, 2025 (CN) 202510536622.4

(51) Int. Cl. H04N 21/854; G10L 13/02; H04N 21/2187; H04N 21/234; H04N 21/81

(52) U.S. Cl. CPC H04N 21/854; G10L 13/02; H04N 21/2187; H04N 21/23424; H04N 21/8106

(57) ABSTRACT

A method for generating a live streaming script, an electronic device and a storage medium are provided, which relate to the field of artificial intelligence technologies, in particular to the fields of natural language processing, large models, and virtual digital characters. The method for generating a live streaming script includes: generating at least one first script segment according to an initial input information, where the first script segment includes a speech content text and an object description sub-segment for a live streaming object, the object description sub-segment includes an object description text for describing at least one of an action presented by the live streaming object or a presentation mode for the speech content text; and determining the live streaming script according to the at least one first script segment.

This application claims the benefit of priority to Chinese Patent Application No. 202510536622.4, filed on Apr. 25, 2025. The entire contents of this application are hereby incorporated herein by reference.

### TECHNICAL FIELD

The present disclosure relates to a field of artificial intelligence technologies, in particular to the fields of natural language processing, large models, and virtual digital characters, and may be applied to scenarios of virtual character live streaming. More specifically, the present disclosure provides a method for generating a live streaming script, an electronic device, and a storage medium.

### BACKGROUND

With the development of artificial intelligence technologies, the application of virtual digital characters has been continuously increasing. A virtual digital character may replace a real host and achieve uninterrupted around-the-clock live streaming.

### SUMMARY

The present disclosure provides a method for generating a live streaming script, an electronic device, and a storage medium.

According to an aspect of the present disclosure, a method for generating a live streaming script is provided, including: generating at least one first script segment according to an initial input information, where the first script segment includes a speech content text and an object description sub-segment for a live streaming object, the object description sub-segment includes an object description text for describing at least one of an action presented by the live streaming object or a presentation mode for the speech content text; and determining the live streaming script according to the at least one first script segment.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method provided by the present disclosure.

According to another aspect of the present disclosure, a non-transitory computer-readable storage medium having computer instructions therein is provided, and the computer instructions are configured to cause a computer to implement the method provided by the present disclosure.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute any limitation to the present disclosure. In the accompanying drawings:

FIG. 1 shows a schematic diagram of an exemplary system architecture to which a method and apparatus for generating a live streaming script may be applied according to an embodiment of the present disclosure;

FIG. 2 shows a flowchart of a method for generating a live streaming script according to an embodiment of the present disclosure;

FIG. 3 shows a schematic diagram of a method for generating a live streaming script according to an embodiment of the present disclosure;

FIG. 4 shows a flowchart of a method for generating a live streaming script according to another embodiment of the present disclosure;

FIG. 5 shows a block diagram of an apparatus for generating a live streaming script according to an embodiment of the present disclosure; and

FIG. 6 shows a block diagram of an electronic device to which the method for generating a live streaming script may be applied according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In the technical solutions of the present disclosure, the collection, storage, use, processing, transmission, provision, disclosure, and other processing of user personal information all comply with relevant laws and regulations and do not violate public order and good customs.

With the rapid development of the e-commerce live streaming industry, live streaming for product sales has gradually become an important marketing approach. However, live hosts have limited energy, and operation costs of live streaming are very high. Since it is difficult for a real host to achieve uninterrupted, around-the-clock live streaming, technologies of “digital character live streaming” based on artificial intelligence may be applied to reduce operation costs and achieve continuous live streaming. “Digital character live streaming” refers to the use of a virtual digital character to replace a real host in a live streaming room to execute a series of live streaming tasks, such as product presentation, interactive question-and-answer, and user guidance. Digital character live streaming integrates multiple advanced technologies: generating live streaming scripts based on large language models (LLMs), synthesizing natural speech through text-to-speech (TTS) technology, and combining a lip motion synthesis system to achieve a “speech-lip synchronized” driving effect. Each stage of this process is usually executed in a decoupled manner with low interdependence, thereby forming a “static generation+sequential driving” technical path. Compared with a real host, a digital character is capable of 24-hour uninterrupted live streaming and demonstrate significant advantages in cost reduction, efficiency improvement, exposure expansion, and controllability. The digital character live streaming technology is effective when dealing with live streaming content having relatively simple structures and fixed scenarios. For example, a digital character may be applied in low-interaction scenarios such as looped promotional video-style live streaming or single-product display. In such low-interaction scenarios, a digital character has small movement ranges and limited facial expression changes, and almost no real-time interaction with the audience is performed, such that the expressiveness and stability of the digital character may be maintained.

However, as live streaming for product sales develops toward highly interactive and emotion-driven formats, live streaming scenarios involve stronger requirements for expressive capability (e.g., emotional intensity such as excitement, surprise, or emphasis), more complex action coordination (e.g., object interactions or large-scale body actions), and increased real-time interaction with users (e.g., responding to bullet comments, distributing promotional gifts, or reacting to price changes). The above-mentioned static and decoupled technical path is insufficient to support such high-interaction and emotion-intensive scenarios.

In a low-interaction scenario, a script used for live streaming may be generated in advance and cannot respond in real time to changes occurring in the live streaming room, thus lacking flexibility. In addition, during live streaming, the speeches, actions, and facial expressions of the digital character are generated by different and relatively independent modules, making it difficult to achieve a high level of multimodal coordination. As a result, a visual presentation appears unnatural, an interactive experience is inadequate, and an overall expressiveness of digital character live streaming is significantly inferior to that of real hosts. The following description will be provided in relation to issues such as live streaming scripts, actions of digital character hosts, tools in the live streaming room, responses to changes in the live streaming room, and multi-host live streaming.

The live streaming scripts used in digital character live streaming lack attractiveness. The majority of live streaming scripts are generated in a templated manner, resulting in homogenized content that lacks novelty and fails to effectively capture the interest of viewers. Expressions such as “the lowest price on the web” or “miss it today, wait another year” are excessively used, causing users fatigue and making it difficult to leave a lasting impression. In addition, it is difficult to customize the content of the scripts according to product characteristics, host persona, or target viewers, leading to a flat atmosphere in the live streaming room, with limited emotional fluctuation or dramatic intensity, and making it difficult to generate content “highlights” or achieve “breakthrough” dissemination. Such scripts lack storytelling, interactivity or emotional appeal, making it difficult for digital characters to truly engage the viewers during live streaming.

Furthermore, during live streaming, digital character hosts struggle to demonstrate highly expressive actions. The action performance of digital character hosts remains limited. The actions of a digital character are mainly restricted to lip synchronization with speech, a small number of basic facial expressions, and gesture-driven actions, making it difficult to present actions that are highly matched to semantics of the script. When delivering emotions such as excitement, surprise, or emphasis, the amplitude of actions of the digital character is often insufficient, and changes in facial expressions are not sufficiently nuanced, such that emotional fluctuations and variations in tone cannot be effectively conveyed, resulting in an overall performance that appears rigid and “mechanical”. Particularly in live streaming for product sales, such unconvincing action expression may fail to arouse the emotions of viewers and cannot create a “strong sense of immersion” in the viewing experience. Moreover, delays, misalignments, or inconsistencies may occur between the actions or facial expressions and the speech or tone of the digital character, which further diminishes the immersion and professionalism of the live streaming. Compared with real hosts, digital characters remain less natural and fluent, resulting in clear disadvantages in strengthening brand impression and improving live streaming conversion.

Moreover, digital characters face difficulties in operating various props in a live streaming room. Most digital character live streaming systems have limited support for physical or virtual props in live streaming scenarios and lack the capability for in-depth scheduling of “interactive props”. Actions such as switching promotional materials, distributing promotional gifts, displaying limited-time prompts, and guiding bullet comment interactions often fail to achieve accurate synchronization with the script content. Many actions performed by digital characters still depend on manual intervention or backend operation and maintenance, lacking automation and script-driven capability. This causes disruptions in the rhythm of live streaming and reduces the effectiveness of interaction. In scenarios involving two or more digital characters collaborating in live streaming, problems such as repeated operations on the same props by different characters, information conflicts, or logical disorder frequently occur, adversely affecting the overall quality of live streaming. In addition, the use of props lacks contextualized design. For instance, when introducing skincare products, a digital character host struggles to naturally “pick up” the product or demonstrate packaging details.

Further, digital characters have difficulty in achieving dynamic presentation in response to changes occurring in the live streaming room. Driven by static and predetermined scripts, digital characters are unable to perceive or respond to real-time changes during live streaming. As a result, the presentation content cannot be flexibly adapted to on-site situations, lacking the capability of “on-the-spot adaptability”. When product inventory changes unexpectedly, when viewers frequently ask about a specific feature in comments, or when interactive information pops up on screen, digital character hosts often cannot promptly adjust their speech or shift the focus of presentation, but instead mechanically follows predetermined lines, thereby severely affecting user experience. In addition, digital characters generally lack the ability to perceive and respond to real-time data such as viewer emotions, bullet comment feedback, product popularity, or fluctuations in the number of viewers, and thus cannot implement adaptive “opportunity-driven” sales strategies. When a particular product receives a significant increase in attention, the digital character cannot immediately shift to highlighting the product, nor can it proactively generate personalized responses or interactive question-and-answer based on user interests, thus missing key opportunities for guiding conversions.

Further, in a case of multiple digital characters, it is difficult to achieve a natural multi-host live streaming effect. In complex live streaming room scenarios, multiple digital characters representing different roles need to work collaboratively. These roles may include hosts, co-hosts, moderators, on-site controllers, brand representatives, and so forth. The roles are required to coordinate in real time, complement one another, and interact collaboratively to create a lively, smooth, and layered live streaming atmosphere. However, multiple digital characters are unable to simulate the natural interaction patterns involving multiple hosts in a real live streaming room, such as “overlapping speech”, “cutting in”, “echoing”, or “cross talk”.

To achieve digital character live streaming with “strong expressiveness, strong interactive engagement, and strong sales capabilities”, it is necessary to adopt a more integrated, intelligent, and real-time collaborative generation paradigm for producing live streaming scripts. Accordingly, the present disclosure provides a method for generating a live streaming script, which will be described below.

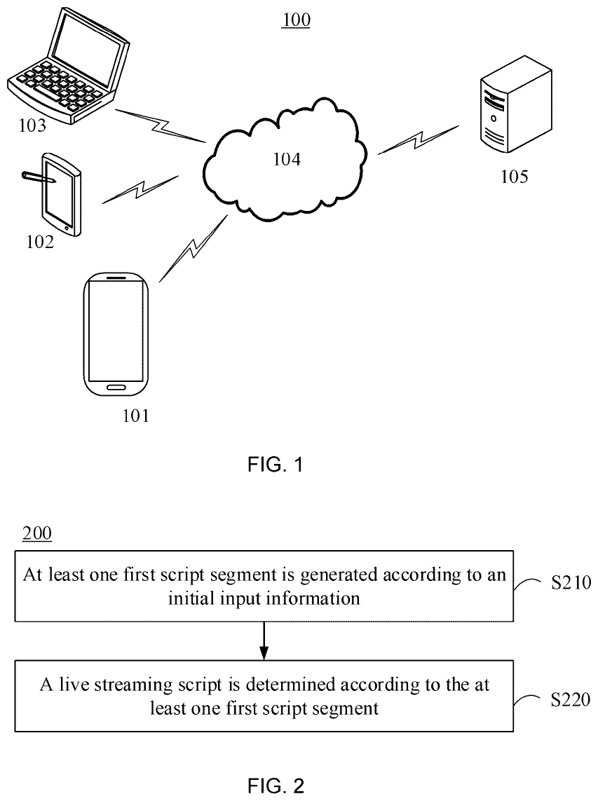

FIG. 1 shows a schematic diagram of an exemplary system architecture to which a method and apparatus for generating a live streaming script may be applied according to an embodiment of the present disclosure. It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios.

As shown in FIG. 1, a system architecture 100 according to such embodiment may include terminal devices 101, 102, 103, a network 104, and a server 105. The network 104 is a medium for providing a communication link between the terminal devices 101, 102, 103 and the server 105. The network 104 may include various types of connections, such as wired and/or wireless communication links, and the like.

The terminal devices 101, 102, 103 may be used by a user to interact with the server 105 through the network 104 to receive or send messages, etc. The terminal devices 101, 102, 103 may be various electronic devices having display screens and supporting web browsing, including but not limited to smart phones, tablet computers, laptop computers, and desktop computers, etc.

The server 105 may be a server providing various services, such as a background management server (for example only) that provides support for websites browsed by the user using the terminal devices 101, 102, 103. The background management server may analyze and process received data such as a user request, and return a processing result (such as a web page, information or data acquired or generated according to the user request) to the terminal devices.

It should be noted that the method for generating a live streaming script provided in embodiments of the present disclosure may generally be performed by the server 105. Accordingly, the apparatus for generating a live streaming script provided in embodiments of the present disclosure may generally be disposed in the server 105. The method for generating a live streaming script provided in embodiments of the present disclosure may also be performed by one or more of the terminal devices 101, 102, 103. Accordingly, the apparatus for generating a live streaming script provided in embodiments of the present disclosure may also be disposed in one or more of the terminal devices 101, 102, 103. The method for generating a live streaming script provided in embodiments of the present disclosure may also be performed by a server or server cluster different from the server 105 and capable of communicating with the terminal devices 101, 102, 103 and/or the server 105. Accordingly, the apparatus for generating a live streaming script provided in embodiments of the present disclosure may also be disposed in a server or server cluster different from the server 105 and capable of communicating with at least of the terminal devices 101, 102, 103 or the server 105.

It should be understood that the system architecture of the present disclosure has been described above. A description of the method of the present disclosure will be provided below.

FIG. 2 shows a flowchart of a method for generating a live streaming script according to an embodiment of the present disclosure.

As shown in FIG. 2, a method 200 may include operation S210 to operation S220.

In operation S210, at least one first script segment is generated according to an initial input information.

In an embodiment of the present disclosure, the initial input information may include information related to an object to be presented. For example, the object to be presented may be a product presented during live streaming, and the initial input information may include a description of the product.

In an embodiment of the present disclosure, the first script segment includes a speech content text and an object description sub-segment for a live streaming object. For example, during live streaming, a digital character host may present audio corresponding to the speech content text in the form of dialogue, speech, or the like.

In an embodiment of the present disclosure, the first script segment may be generated by using a large language model.

In an embodiment of the present disclosure, the object description sub-segment includes an object description text. The object description text may describe at least one of an action presented by the live streaming object or a presentation mode for the speech content text. For example, the object description text may describe one or more actions presented by the live streaming object. For another example, the object description text may describe a presentation mode for the speech content text. The presentation mode may include tone, and the tone may be calm, enthusiastic, etc.

In an embodiment of the present disclosure, the live streaming object may be a digital character host.

In operation S220, a live streaming script is determined according to the at least one first script segment.

In an embodiment of the present disclosure, one or more first script segments may serve as one or more live streaming script segments of the live streaming script. For example, the first script segment may serve as the live streaming script segment.

According to an embodiment of the present disclosure, when generating the speech content text, an object description sub-segment is generated, such that the speech content of the digital character is more coordinated with the actions of the live streaming object, thereby providing richer information for subsequent generation of live streaming video. After the live streaming script is provided to a large model, the large model may generate a live streaming draft having coherent content logic and may further synchronously control multimodal behaviors of the digital character. The live streaming script provided by the present disclosure may thus be implemented as an “executable script” in the true sense, enabling digital character live streaming to transform from a single scenario to multidimensional, highly interactive, and highly expressive scenarios.

It should be understood that the method of the present disclosure has been described above. A description of the live streaming object and the object description sub-segment will be provided below.

In some embodiments, at least one live streaming object is provided, and the at least one live streaming object includes at least one of a virtual character or an object to be presented. For example, one or more virtual characters may be provided. The one or more virtual characters may include various digital characters such as a digital character host, a digital character co-host, a digital moderator, a digital on-site controller, or a digital brand representative. For another example, the object to be presented may be a product or service presented during live streaming. The service may include, for example, travel services, legal services, etc. The product may include, for example, skincare products, handbags, etc.

In some embodiments, the object description sub-segment may be embedded in the speech content text. For example, a plurality of object description sub-segments may be embedded at a plurality of positions in the speech content text.

In some embodiments, the object description sub-segment may further include at least one of a presentation indicator, a sub-segment start delimiter, a sub-segment end delimiter, or a separator. The presentation indicator may be a name of the presentation mode, an “action”, or a “facial expression”. Based on the presentation indicator, a large model may generate audio, image, or text data corresponding to the presentation indicator according to the object description text. The sub-segment start delimiter may be a symbol such as “(” or “ [symbol] ”. The sub-segment end delimiter may be a symbol such as “)” or “ [symbol] ”. The separator may be a symbol such as “:” or “|”.

For example, a portion of the first script segment of the present disclosure is as follows.

“//Host: (Tone: calm) (Action: picks up two opened product boxes, puts down the one in the left hand, and points to the contents of the one in the right hand while explaining the usage method) Look, the usage is very simple (Co-host says at the same time: Very simple!), use it once a month, continuously for six months, then take a break for six months, only two boxes are needed per year. Each time, mix agent A and agent B, then use the matching roller to perform micro-needling with slight skin penetration. It does not hurt and has a short recovery period. After use, avoid water contact within twelve hours and remember to protect your skin from the sun.

Host: (Tone: calm) (Action: picks up the packaged roller on the table to show, while the co-host gestures in front of the face to demonstrate the use of the roller) This roller is a tool to be used together with the product. It helps the nutrients penetrate and absorb better. Just like loosening the soil so the nutrients of seeds can take root and sprout better, the skin can absorb the nutrients more effectively.

Co-host: (Tone: calm) (Action: brings in a toolkit from off-screen and opens it for display, while the host opens the roller package and takes out the roller to show) Hey folks, everything in the toolkit has been prepared for you (Host says at the same time: So thoughtful!), you can start using it as soon as you receive it, very convenient. Also, our product is painless with a short recovery period, and won't interfere with your daily life.

Co-host: (Tone: enthusiastic) (Action: takes out two bottles of solution from the product box and shows them side by side, then puts them back into the box) Look, these two bottles are agent A and agent B. When combined, they produce powerful results. Just like two superheroes teaming up, they can defeat various skin problems and make your skin bright, tender, and smooth!

Host: (Tone: enthusiastic) (Facial expression: happy) Hey everyone, with such a good product and so many benefits, what are you still waiting for?Opportunities like this are rare, and stock is limited. If you miss this time, it may be a long wait before you get such a discount again!.

Co-host: (Tone: enthusiastic) (Action: picks up a plastic board showing before-and-after photos of product usage and introduces the results) (Facial expression: surprised) Hey folks, take a look at these comparison photos, the effect is really immediate! (Host says at the same time: This is amazing!) Before using it, the skin had various problems. After using it, the skin became much better. Don't you also want skin like this?”

As illustrated in this portion of the first script segment, the plurality of object description sub-segments may include: (Tone: calm), (Action: picks up two opened product boxes, puts down the one in the left hand, and points to the contents of the one in the right hand while explaining the usage method), (Facial expression: happy), etc. Taking the object description sub-segment (Tone: calm) as an example, “Tone” may serve as a presentation indicator, “calm” may serve as an object description text, “(” may serve as a sub-segment start delimiter, and “)” may serve as a sub-segment end delimiter. “:” may serve as a separator between the presentation indicator “Tone” and the object description text “calm”. In addition, this portion of the first script segment involves a plurality of virtual characters, including a digital character host and a digital character co-host. It should be understood that the presentation indicator, the sub-segment start delimiter, the sub-segment end delimiter, and the separator illustrated in this portion of the first script segment are merely examples. According to embodiments of the present disclosure, an object description sub-segment in the form of (presentation indicator: object description text) is provided, so that information such as tone, action, facial expression, and prop scheduling may be structurally embedded into the live streaming script, enabling a large language model to generate logically coherent live streaming copy and to effectively control multimodal behaviors of digital characters, including tone, actions, and facial expressions.

In some embodiments, the object description sub-segment may be one of an object presentation-mode description sub-segment, an object action description sub-segment, or an object expression description sub-segment. The object presentation-mode description sub-segment includes an object presentation-mode description text. The object action description sub-segment includes an object action description text. The object expression description sub-segment includes an object expression description text. For example, as illustrated in the above portion of the first script segment, the object description sub-segment (Tone: calm) may serve as the object presentation-mode description sub-segment and may include the object presentation-mode description text “calm”. The object description sub-segment (Action: picks up two opened product boxes, puts down the one in the left hand, and points to the contents of the one in the right hand while explaining the usage method) may serve as the object action description sub-segment and may include the object action description text “picks up two opened product boxes, puts down the one in the left hand, and points to the contents of the one in the right hand while explaining the usage method”. The object description sub-segment (Facial expression: happy) may serve as the object expression description sub-segment and may include the object expression description text “happy”. It should be understood that when the presentation mode is a tone, the object presentation-mode description sub-segment may also be referred to as an object tone description sub-segment, and the object presentation-mode description text may also be referred to as an object tone description text.

It may be understood that the object description sub-segment of the present disclosure has been described above. A further description of the first script segment and the function of the object description sub-segment will be provided below.

In some embodiments, the live streaming script may be used to generate a live streaming video. The live streaming video may include a first video segment corresponding to the first script segment. For example, the live streaming video may be obtained by inputting the live streaming script into a large model. One or more first script segments may be provided, and the live streaming video may include one or more first video segments, each first script segment corresponding to a first video segment.

In some embodiments, audio data for the speech content text in the first video segment is generated according to a presentation mode described by the object presentation-mode description text. For example, the audio data for the speech content text “Look, the usage is very simple” is generated according to the “tone” described by the object presentation-mode description text “calm”.

In some embodiments, image data for a virtual character in the first video segment is generated according to at least one of the object action description text or the object expression description text. The object action description text describes at least one body action of the virtual character. The at least one body action may include a first body action for the object to be presented, and may further include a second body action of the live streaming object. For example, the object action description text “picks up two opened product boxes, puts down the box in the left hand, and points to the contents of the box in the right hand while explaining the usage method” may describe at least one first body action for the object to be presented, i.e., the “product”. For another example, the object action description text “walk to the center of the video frame” may describe a second body action of the virtual character.

In some embodiments, the object expression description text may describe at least one facial action of the virtual character. For example, the object expression description text “happy” may describe one or more facial actions of the virtual character. The one or more facial actions may represent a happy expression.

Through embodiments of the present disclosure, the object description sub-segment (presentation indicator: object description text) may be flexibly adapted to different types of live streaming scenarios, including various vertical scenarios such as cosmetics and skincare, health and nutrition, and home appliances and digital products. Taking a cosmetics scenario as an example, if the script includes an object action description sub-segment, the digital character host may automatically perform actions such as “applying the product”, “gesturing to facial areas”, or “showing a combination set” while explaining the product efficacy, thereby making the product information more vivid and persuasive. For another example, in a health and nutrition scenario, if the script includes an object action description sub-segment, the digital character co-host may automatically perform actions such as “opening product packaging”, “demonstrating intake methods”, or “holding a sign to highlight precautions”, thereby improving the viewers' understanding of the usage method and trust in the product.

Furthermore, through embodiments of the present disclosure, based on the first body action for the object to be presented, a linkage control between the script and the digital character action, the live streaming props may be achieved, and the system achieves a three-dimensional coordinated expression of semantics, vision, and interaction, enabling the digital character not only to “speak”, but also to “act”, “move”, and “demonstrate” during the live streaming. During a product introduction process, the digital character may naturally lift the product, operate props, display comparison charts, and even cooperate with a co-host to complete a “demonstration-style explanation”, thereby significantly enhancing the efficiency of information transmission and the viewing experience. Such immersive form of expression greatly improves user's viewing focus and content memory, providing a content foundation for subsequent conversion behavior.

In some embodiments, the first script segment includes a plurality of speech content texts respectively corresponding to a plurality of virtual characters. The object description sub-segment for the live streaming object is embedded in the speech text for the virtual character. As illustrated in the above portion of the first script text, the plurality of virtual characters include the digital character host and the digital character co-host. The object description sub-segment (tone: calm) for the digital character host is embedded in the speech content text for the digital character host. The object description sub-segment (tone: enthusiastic) for the digital character co-host is embedded in the speech content text for the digital character co-host.

Through embodiments of the present disclosure, the object description sub-segment (presentation indicator: object description text) supports multi-character collaborative modeling. In a script generation stage, speech content and action positioning may be generated separately for the host, the co-host, the on-site controller and other characters, thereby refining character positioning and functional division, and improving efficiency of multi-character collaboration. For example, the co-host may focus on creating atmosphere, supplementing details, and promoting interaction, while the host may focus on explaining core content of the product, thus forming an efficient collaboration in the script.

It may be understood that the first script segment of the present disclosure has been described above. A further description of the method of the present disclosure will be provided below.

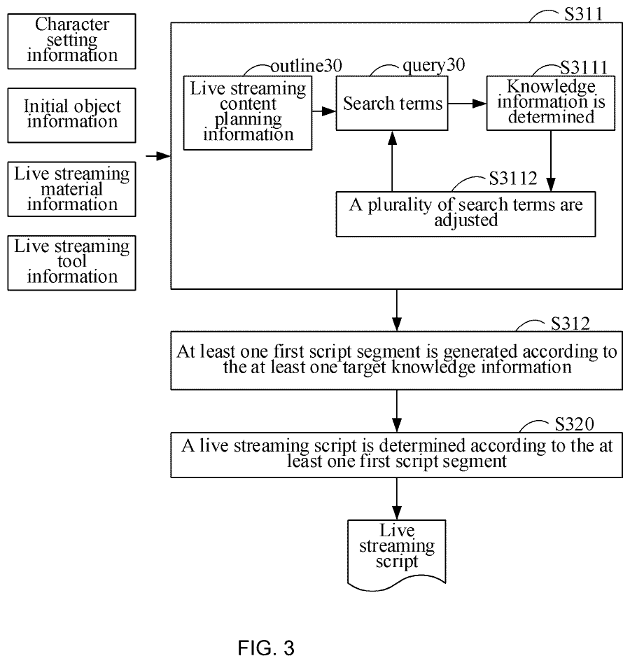

FIG. 3 shows a schematic diagram of a method for generating a live streaming script according to an embodiment of the present disclosure.

In some embodiments, the initial input information includes at least one of a character setting information for a virtual character, an initial object information for an object to be presented, a live streaming material information, or a live streaming tool information. One or more initial object information may be provided. For example, if the object to be presented is a product to be presented, the plurality of initial object information may correspond to information for a plurality of products. The live streaming material information may indicate a plurality of materials, which may be used for one or more products. The live streaming tool information may indicate a plurality of live streaming tools available in a live streaming room. The plurality of live streaming tools may include a bullet-comment tool, a comment tool, and the like. One or more character setting information may be provided, and a plurality of character setting information are respectively used for a plurality of virtual characters. For example, the character setting information may provide a stylized persona for a virtual character, so that the large model may flexibly adjust content style according to requirements of the stylized persona and multiple dimensions such as live streaming objectives, viewer profiles, and product attributes, thereby ensuring that the script style is highly matched to the live streaming scenario. In an example, in a “knowledge dissemination” scenario, based on a style corresponding to the scenario, the script may incorporate professional terminology, case analyses, and knowledge extensions from an appropriate knowledge base, thereby making the live streaming more authoritative and educational. In another example, in an “experience sharing” scenario, the large model may adjust speaking speed, emotional curve, and narrative manner in the script, focusing more on semantic resonance and viewer immersion. By introducing the character setting information, it is possible to achieve a flexible and customized style control, so that the script demonstrates good adaptability and appeal across different vertical domains and target viewers.

In some embodiments, in some implementations of the aforementioned operation S210, generating at least one first script segment according to the initial input information includes: determining at least one target knowledge information according to a knowledge base and at least one of the character setting information, the at least one initial object information, the live streaming material information, or the live streaming tool information. As shown in FIG. 3, a deep reasoning and knowledge enhancement operation S311 may be performed according to one or more of the character setting information, the at least one initial object information, the live streaming material information, or the live streaming tool information, to determine the target knowledge information from the knowledge base. Then, operation S312 is performed to generate at least one first script segment according to the at least one target knowledge information. Operation S311 and operation S312 will be further described below.

In some embodiments, determining at least one target knowledge information according to a knowledge base and at least one of the character setting information, the at least one initial object information, the live streaming material information, or the live streaming tool information includes: determining a live streaming content planning information according to at least one of the character setting information, the at least one initial object information, the live streaming material information, or the live streaming tool information. The live streaming content planning information may indicate that the first script segment includes at least one of an introduction text for the object to be presented, a historical case text for the object to be presented, or a guidance text for the object to be presented. For example, the live streaming content planning information may indicate respective objects to be presented of the plurality of first script segments. One or more first script segments may be generated for each object to be presented. The live streaming content planning information may further indicate that the first script segment for the object to be presented includes an introduction text, a historical case text, and a guidance text. Alternatively, the live streaming content planning information may indicate that three first script segments for the object to be presented respectively include an introduction text, a historical case text, and a guidance text. The introduction text may be a description of the object to be presented. The historical case text may be a description of cases in which different users have used the object to be presented. The guidance text may be used to guide the user to perform an action on the object to be presented. For example, in the aforementioned portion of the first script segment, the speech content text “use it once a month, continuously for six months, then take a break for six months, only two boxes are needed per year. Each time, mix agent A and agent B, then use the MTS roller to perform micro-needling with slight skin penetration. It does not hurt and has a short recovery period” may serve as an introduction text. The speech content text “Hey folks, take a look at these comparison photos, the effect is really immediate!” may serve as a historical case text. The speech content text “Don't you also want skin like this?” may serve as a guidance text.

In some embodiments, determining at least one target knowledge information according to the knowledge base and at least one of the character setting information, the at least one initial object information, the live streaming material information, or the live streaming tool information includes: determining a plurality of initial search terms according to the live streaming content planning information, and determining the target knowledge information according to the plurality of initial search terms and the knowledge base. As shown in FIG. 3, a plurality of initial search terms query 30 may be determined according to a live streaming content planning information outline 30. Then, operation S3111 may be performed to determine knowledge information according to the plurality of initial search terms query 30 and the knowledge base. In this way, through the live streaming content planning information and combined with a knowledge enhancement mechanism based on in-depth retrieval, the script generation process is linked with multi-source knowledge bases. The multi-source knowledge bases may include an object detail knowledge base, a real case knowledge base, and an industry encyclopedia knowledge base. The multi-source knowledge bases may serve as external knowledge systems to enable “information-driven” script content generation. For example, if the object to be presented is a product to be presented, it is possible to extract product efficacy, usage methods, core ingredients, and authoritative endorsements as knowledge in the product detail knowledge base, such that the information of the object to be presented may be naturally integrated into the speech content of the virtual character. For the real case knowledge base, user reviews, usage feedback, and actual conversion results may be used as knowledge in the real case knowledge base. For the industry encyclopedia knowledge base, external professional knowledge may be accessed and reasonably extended, for example, to introduce dermatological background into the speech content about skincare ingredients. Through the knowledge bases of the present disclosure, multi-source knowledge integration may be achieved, such that the script is not “hollow praise” or “formulaic sales talk”, but rather content that is logical, structured, and professional. It should be understood that the multi-source knowledge bases may include preconfigured knowledge bases, and/or knowledge bases obtained through online data retrieval.

Furthermore, it is also possible to perform multi-round retrieval based on the initial search terms to acquire knowledge more accurately and comprehensively. In some embodiments, the initial search terms may serve as first-level search terms to perform N rounds of retrieval in the knowledge base, thereby obtaining at least one target knowledge information, where N may be an integer greater than 1. An n^{th}-level retrieval result may be determined from a preconfigured database according to a plurality of n^{th}-level search terms. An n^{th} level knowledge information may be determined according to the n^{th}-level retrieval result. According to the n^{th}-level retrieval result and the plurality of n^{th}-level search terms, operation S3112 may be performed to adjust the plurality of search terms to determine a plurality of (n+1)^{th}-level search terms. Then, retrieval may be performed in the knowledge base based on the (n+1)^{th}-level search terms. At least one target knowledge information may be determined according to an N^{th}-level retrieval result. n may be an integer greater than or equal to 1 and less than N. In a case where a plurality of objects to be presented are provided, the target knowledge information for each object to be presented may be determined from the N^{th}-level retrieval result. According to embodiments of the present disclosure, through multi-round retrieval combined with the aforementioned object description sub-segments, an integration mechanism of structured information embedding, live streaming content planning, and deep retrieval may be achieved, which may significantly improve the quality of the script. As a result, the live streaming script may include multimodal coordinated content such as tone, actions, facial expressions, and prop instructions, endowing the digital character with realistic expressiveness. In addition, through embodiments of the present disclosure, the live streaming content may be more engaging, with more rhythmical narration, diverse language styles, clear logic, and rich information, which effectively avoids the problems of conventional scripts being templated and formulaic. Accordingly, users are more likely to be emotionally moved during viewing, thereby generating emotional resonance.

It should be understood that the deep reasoning and knowledge enhancement operation of the present disclosure has been described above. The following will describe operation S312.

As shown in FIG. 3, in operation S312, at least one first script segment is generated according to the at least one target knowledge information. For example, the first script segment may be generated using a large model according to the target knowledge information for an object to be presented.

Then, operation S320 may be performed to determine a live streaming script according to the at least one first script segment.

In some embodiments, it may be determined whether a difference between the first script segment and the character setting information is less than a predetermined difference threshold. For example, it is possible to extract a style feature of the virtual character from the first script segment, and determine a difference between the style feature and a feature of the character setting information.

In some embodiments, in response to determining that the difference between the first script segment and the character setting information is less than the predetermined difference threshold, the first script segment is determined as a live streaming script segment of the live streaming script. For example, in a case of a small difference between a style feature of a virtual character of the first script segment and the character setting information for the virtual character, the first script segment may serve as a live streaming script segment.

In other embodiments, in response to determining that the difference between the first script segment and the character setting information is greater than or equal to the predetermined difference threshold, a first adjusted script segment is determined as a live streaming script segment of the live streaming script. The first adjusted script segment is obtained by adjusting the first script segment. For example, in a case of a large difference between a style feature of a virtual character of the first script segment and the character setting information for the virtual character, it is possible to adjust a style of the first script segment using a large model to reduce the difference between the style feature and the character setting information.

It may be understood that “persona” of the host and/or co-host in live streaming is a key information for attracting users, forming memorable impressions, and building trust. Accordingly, in order to maintain consistency of language style and behavioral logic of a character and to avoid “persona drift” during a long-duration script generation, the character setting information is introduced in the present disclosure to achieve a tagged construction of the host character (for example, defining personality traits, language style, identity background, and expression habits of the virtual character) prior to script generation, and a dynamic constraint is further performed according to the difference between the script segment and the character setting information, ensuring that the language style and behavioral logic of the virtual character remain consistent with the persona. By determining the difference between the first script segment and the character setting information, continuity of persona expression may be continuously monitored during the script generation, and potential persona deviation may be automatically identified and corrected, thereby avoiding problems such as inconsistent tone, conflicts in values, and logical reversals. For example, for a “rational-type” virtual host, the script segment for the host should include speech content supported by data, analysis, and logical reasoning to substantiate viewpoints. For another example, a “friendly-type” virtual host is more likely to use affectionate phrases such as “hey folks” or “hey everyone, look here” to create a sense of closeness. Through embodiments of the present disclosure, a full-cycle management of persona from “language style shaping” to “behavioral consistency control” may be achieved, effectively addressing problems of persona fragmentation or collapse. In addition, to enable the generation of a long script, a long-script segmented writing workflow is introduced in the present disclosure. Combined with the live streaming content planning information, one or more first script segments may be generated for each object to be presented, enabling a one-time generation of scripts with 5,000 to 10,000 words, which meets the requirements of long-duration live streaming sessions of 15 to 30 minutes.

It may be understood that the method for generating a static live streaming script prior to live streaming has been described above. The following will describe the generation of a dynamic script during live streaming.

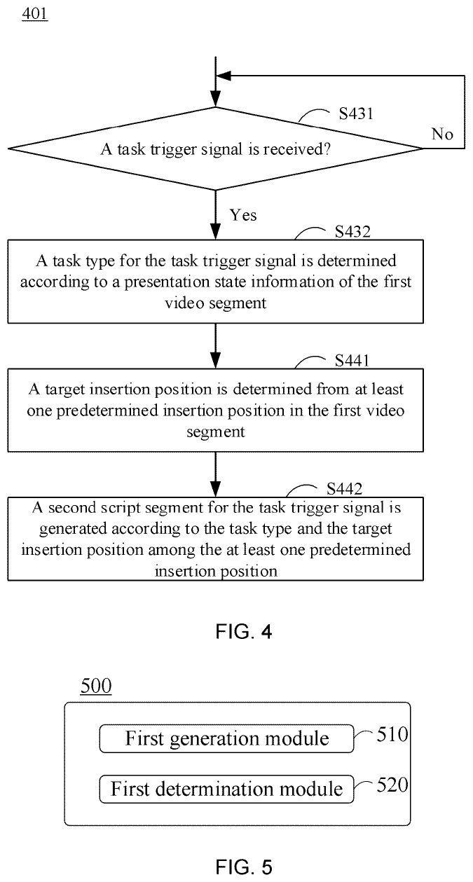

FIG. 4 shows a flowchart of a method for generating a live streaming script according to another embodiment of the present disclosure.

A method 401 may be performed after the aforementioned method 200, and the following description will be provided in conjunction with operation S431, operation S432, operation S441, and operation S442.

In operation S431, it is determined whether a task trigger signal is received.

In some embodiments, in response to determining that a target behavior does not meet a trigger logic, operation S431 continues to be executed.

In some embodiments, in response to determining that a target behavior in the live streaming room meets the trigger logic, operation S432 is executed. For example, after a live streaming script has been generated and a live streaming video has been generated using a large model, a plurality of first video segments may be played in sequence for the live streaming. During playback of the first video segments, various behavior signals in the live streaming room may be monitored. Multiple behavior signals may correspond to multiple behaviors, including user entry, exit, likes, comments, dwell time, product clicks, and the like. In addition, user-submitted questions or interaction requests may be acquired. When one or more of these behaviors meet specific trigger logic, a task trigger signal may be generated. The trigger logic may include that the number of occurrences of particular behavior is greater than or equal to a predetermined threshold number. Taking a product click behavior as an example, if a click volume on a product page increases rapidly and reaches or exceeds a predetermined click volume threshold, a signal may be triggered as a task trigger signal for the corresponding first video segment. This signal may be received by a large model for script generation, and operation S432 may be executed.

In operation S432, a task type for the task trigger signal is determined according to a presentation state information of the first video segment.

In some embodiments, the presentation state information may include at least one of a playback progress information of the first video segment, a task execution progress information for the first video segment, or a state information of the virtual character. The first video segment may be further divided into a plurality of video sub-segments. The playback progress information may indicate respective playback states of the plurality of video sub-segment. The plurality of video sub-segments respectively correspond to a plurality of importance index values. The task execution progress information may indicate an execution progress of a prior task for the first video segment, to indicate whether the prior task has been executed. The state information may indicate whether the virtual character is present in the video frame. In response to determining that a target video sub-segment has been played and the prior task has been executed, a task type for the task trigger logic is determined. The target video sub-segment refers to a video sub-segment with an importance index value greater than or equal to a predetermined importance index threshold. For example, if the playback of a target video sub-segment related to key content has completed, the prior task has been executed, and the behavior associated with the prior task is different from the behavior resulting in the generation of the task trigger signal, then the task type for the task trigger signal may be determined. Examples of task types include invitations for reviews, user Q&A, user behavior feedback, and the like. Additionally, a task queue may be provided, a pending task may be added to the task queue, and a priority of the pending task may be determined. Tasks in the task queue may be sorted by priority to ensure that the live streaming rhythm and user experience remain consistent even under multi-task competition. It may be understood that the large model may determine the priority of tasks, or the priority of different types of tasks may be predetermined.

In operation S441, a target insertion position is determined from at least one predetermined insertion position in the first video segment.

In some embodiments, the first video segment may include at least one predetermined insertion position. The predetermined insertion position may correspond to an insertable time instant in the first video segment. Inserting a new video segment based on the predetermined insertion position has a minimal impact on the coherence of the script content of the first video segment.

In some embodiments, a plurality of time offset values may be determined according to a plurality of insertable time instants and a task trigger time instant at which a task trigger signal is received. The target insertion position may then be determined from the plurality of predetermined insertion positions according to the plurality of time offset values. A second script segment for the task trigger signal may be generated according to the task type and the target insertion position. For example, the predetermined insertion position corresponding to the smallest time offset value may be determined as the target insertion position.

In operation S442, a second script segment for the task trigger signal is generated according to the task type and the target insertion position among the at least one predetermined insertion position.

In some embodiments, the second script segment includes at least one of a task content text and a content connection text, where the content connection text is generated according to context data at the target insertion position. The second script segment may be used to generate a second video segment to be inserted at the target insertion position. For example, the task content text may be generated by a large model according to the task type. As an example, if the task type is “user Q&A”, an answer text may be generated as the task content text according to the user-submitted question. For another example, a context text for the target insertion position may be acquired from the first script segment according to the target insertion position, and content connection text may then be generated according to the context text. This further ensures that the style of the second script segment is consistent with the task setting information.

In some embodiments, the second script segment may be used to generate a second video segment to be inserted at the target insertion position. For example, in response to determining that a difference between the second script segment and the character setting information is less than the predetermined difference threshold, a second video segment may be generated according to the second script segment. In response to determining that the difference between the second script segment and the character setting information is greater than or equal to the predetermined difference threshold, a second video segment may be generated according to a second adjusted script segment, where the second adjusted script segment is obtained by adjusting the second script segment. It should be understood that the aforementioned description regarding the first script segment and the predetermined difference threshold similarly applies to the second script segment, and details will not be repeated herein.

According to embodiments of the present disclosure, the digital characters may conduct stable live streaming according to a predefined first script segment, and may further implement intelligent responses based on signals received during the live streaming, thereby achieving flexible, natural, and content-rich live streaming interactions, and enhancing user engagement and live streaming conversion rates.

It should be understood that the method of the present disclosure has been described above. A description of an apparatus of the present disclosure will be provided below.

FIG. 5 shows a block diagram of an apparatus for generating a live streaming script according to an embodiment of the present disclosure.

As shown in FIG. 5, an apparatus 500 may include a first generation module 510 and a first determination module 520.

The first generation module 510 is configured to generate at least one first script segment according to an initial input information. The first script segment includes a speech content text and an object description sub-segment for a live streaming object. The object description sub-segment includes an object description text, and the object description text describes at least one of an action presented by the live streaming object or a presentation mode for the speech content text.

The first determination module 520 is configured to determine a live streaming script according to the at least one first script segment.

In some embodiments, at least one live streaming object is provided, including at least one of a virtual character or an object to be presented. The initial input information includes at least one of a character setting information for the virtual character, an initial object information for the object to be presented, a live streaming material information, or a live streaming tool information. The live streaming script is used to generate a live streaming video, and the live streaming video includes a first video segment corresponding to the first script segment.

In some embodiments, the object description sub-segment is embedded in the speech content text. The object description sub-segment further includes at least one of a presentation indicator, a sub-segment start delimiter, a sub-segment end delimiter, or a separator. The separator is located between the presentation indicator and the object description text.

In some embodiments, the object description sub-segment is one of an object presentation-mode description sub-segment, an object action description sub-segment, or an object expression description sub-segment. The object presentation-mode description sub-segment includes an object presentation-mode description text, the object action description sub-segment includes an object action description text, and the object expression description sub-segment includes an object expression description text. Audio data for the speech content text in the first video segment is generated according to a presentation mode described by the object presentation-mode description text. Image data for the virtual character in the first video segment is generated according to at least one of the object action description text or the object expression description text. The object action description text describes at least one body action of the virtual character, and the at least one body action includes at least one first body action for the object to be presented. The object expression description text describes at least one facial action of the virtual character.

In some embodiments, the first generation module includes: a first determination sub-module configured to determine at least one target knowledge information according to a knowledge base and at least one of the character setting information, the at least one initial object information, the live streaming material information, or the live streaming tool information; and a generation sub-module configured to generate the at least one first script segment according to the at least one target knowledge information.

In some embodiments, the first determination sub-module includes: a first determination unit configured to determine a live streaming content planning information according to at least one of the character setting information, the initial object information, the live streaming material information, or the live streaming tool information, where the live streaming content planning information indicates that the first script segment includes at least one of an introduction text for the object to be presented, a historical case text for the object to be presented, or a guidance text for the object to be presented; a second determination unit configured to determine a plurality of initial search terms according to the live streaming content planning information; and a third determination unit configured to determine the at least one target knowledge information according to the plurality of initial search terms and the knowledge base.

In some embodiments, the third determination unit is further configured to perform N rounds of retrieval in the knowledge base according to a plurality of first-level search terms to obtain the at least one target knowledge information, where N is an integer greater than or equal to 1. The first-level search terms are determined according to the initial search terms.

In some embodiments, the third determination unit includes: a first determination sub-unit configured to determine an n^{th}-level retrieval result from a predefined database according to a plurality of n^{th}-level search terms; and a second determination sub-unit configured to determine a plurality of (n+1)^{th}-level search terms according to the n^{th}-level retrieval result and the plurality of n^{th}-level search terms. The at least one target knowledge information is determined according to an N^{th}-level retrieval result. n is an integer greater than or equal to 1 and less than N.

In some embodiments, the first determination module includes: a second determination sub-module configured to, in response to determining that a difference between the first script segment and the character setting information is less than a predetermined difference threshold, determine the first script segment as a live streaming script segment of the live streaming script; and a third determination sub-module configured to, in response to determining that the difference between the first script segment and the character setting information is greater than or equal to the predetermined difference threshold, determine a first adjusted script segment as a live streaming script segment of the live streaming script, where the first adjusted script segment is obtained by adjusting the first script segment.

In some embodiments, the first video segment includes at least one predetermined insertion position. The apparatus further includes: a second determination module configured to, in response to receiving a task trigger signal for the first video segment, determine a task type for the task trigger signal according to a presentation state information of the first video segment; and a second generation module configured to generate a second script segment for the task trigger signal according to the task type and a target insertion position among the at least one predetermined insertion position. The second script segment includes at least one of a task content text or a content connection text, where the content connection text is generated according to context data at the target insertion position. The second script segment is used to generate a second video segment to be inserted at the target insertion position.

In some embodiments, the second script segment indicates generating the second video segment to be inserted at the target insertion position by: in response to determining that a difference between the second script segment and the character setting information is less than the predetermined difference threshold, generating a second video segment according to the second script segment; and in response to determining that the difference between the second script segment and the character setting information is greater than or equal to the predetermined difference threshold, generating a second video segment according to a second adjusted script segment, where the second adjusted script segment is obtained by adjusting the second script segment.

In some embodiments, the presentation state information includes at least one of a playback progress information of the first video segment or a task execution progress information for the first video segment. The first video segment includes a plurality of video sub-segments, which respectively correspond to a plurality of importance index values. The playback progress information indicates respective playback states of the plurality of video sub-segments. The task execution progress information indicates an execution progress of a prior task for the first video segment, where the prior task refers to a task performed before the task trigger signal is received. The second determination module includes: a fourth determination sub-module configured to, in response to determining that a target video sub-segment has been played and the prior task has been executed, determine the task type for the task trigger signal. The target video sub-segment refers to a video sub-segment with an importance index value greater than or equal to a predetermined importance index threshold.

In some embodiments, a plurality of predetermined insertion positions are provided, which respectively correspond to a plurality of insertable time instants in the first video segment. The second generation module includes: a fifth determination module configured to determine a plurality of time offset values according to the plurality of insertable time instants and a task trigger time instant when the task trigger signal is received; a sixth determination sub-module configured to determine a target insertion position from the plurality of predetermined insertion positions according to the plurality of time offset values; and a second generation sub-module configured to generate the second script segment for the task trigger signal according to the task type and the target insertion position.

In the technical solutions of the present disclosure, the collection, storage, use, processing, transmission, provision, disclosure, and other processing of user personal information involved all comply with the provisions of relevant laws and regulations and do not violate public order and good customs.

According to embodiments of the present disclosure, the present disclosure further provides an electronic device, a readable storage medium, and a computer program product.

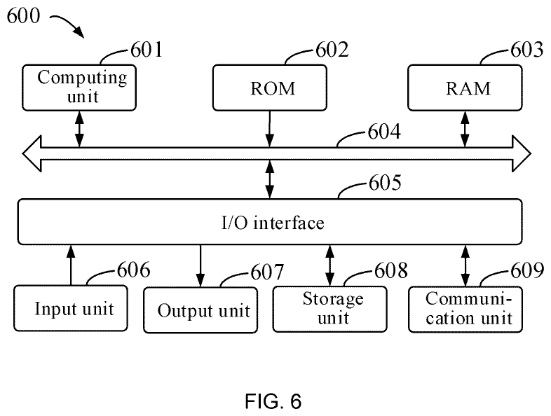

FIG. 6 shows a schematic block diagram of an example electronic device 600 that may be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 600 includes a computing unit 601 which may perform various appropriate actions and processes according to a computer program stored in a read only memory (ROM) 602 or a computer program loaded from a storage unit 600 into a random access memory (RAM) 603. In the RAM 603, various programs and data necessary for an operation of the electronic device 600 may also be stored. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, or a mouse; an output unit 607, such as displays or speakers of various types; a storage unit 608, such as a disk, or an optical disc; and a communication unit 609, such as a network card, a modem, or a wireless communication transceiver. The communication unit 609 allows the electronic device 600 to exchange information/data with other devices through a computer network such as Internet and/or various telecommunication networks.

The computing unit 601 may be various general-purpose and/or dedicated processing assemblies having processing and computing capabilities. Some examples of the computing units 601 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 601 executes various methods and processes described above, such as the method for generating a live streaming script. For example, in some embodiments, the method for generating a live streaming script may be implemented as a computer software program which is tangibly embodied in a machine-readable medium, such as the storage unit 6012. In some embodiments, the computer program may be partially or entirely loaded and/or installed in the electronic device 600 via the ROM 602 and/or the communication unit 609. The computer program, when loaded in the RAM 603 and executed by the computing unit 601, may execute one or more steps in the method for generating a live streaming script described above. Alternatively, in other embodiments, the computing unit 601 may be used to perform the method for generating a live streaming script by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method for generating a live streaming script of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other.

It should be understood that steps of the processes illustrated above may be reordered, added or deleted in various manners. For example, the steps described by the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method for generating a live streaming script, comprising:
generating at least one first script segment according to an initial input information, wherein the first script segment comprises a speech content text and an object description sub-segment for a live streaming object, the object description sub-segment comprises an object description text for describing at least one of an action presented by the live streaming object or a presentation mode for the speech content text; and
determining the live streaming script according to the at least one first script segment.

2. The method of claim 1, wherein at least one live streaming object is provided, the at least one live streaming object comprises at least one of a virtual character or an object to be presented, the initial input information comprises at least one of a character setting information for the virtual character, an initial object information for the object to be presented, a live streaming material information, or a live streaming tool information; and
wherein the live streaming script is used to generate a live streaming video, and the live streaming video comprises a first video segment corresponding to the first script segment.

3. The method of claim 2, wherein the object description sub-segment is embedded in the speech content text, the object description sub-segment further comprises at least one of a presentation indicator, a sub-segment start delimiter, a sub-segment end delimiter, or a separator, and the separator is located between the presentation indicator and the object description text.

4. The method of claim 3, wherein the object description sub-segment comprises one of an object presentation-mode description sub-segment, an object action description sub-segment, or an object expression description sub-segment, the object presentation-mode description sub-segment comprises an object presentation-mode description text, the object action description sub-segment comprises an object action description text, and the object expression description sub-segment comprises an object expression description text;
wherein audio data for the speech content text in the first video segment is generated according to a presentation mode described by the object presentation-mode description text; and
wherein image data for the virtual character in the first video segment is generated according to at least one of the object action description text or the object expression description text, the object action description text describes at least one body action of the virtual character, the at least one body action comprises at least one first body action for the object to be presented, and the object expression description text describes at least one facial action of the virtual character.

5. The method of claim 2, wherein the generating at least one first script segment according to an initial input information comprises:
determining at least one target knowledge information according to a knowledge base and at least one of the character setting information, the at least one initial object information, the live streaming material information, or the live streaming tool information; and
generating the at least one first script segment according to the at least one target knowledge information.

6. The method of claim 5, wherein the determining at least one target knowledge information according to a knowledge base and at least one of the character setting information, the at least one initial object information, the live streaming material information, or the live streaming tool information comprises:
determining a live streaming content planning information according to at least one of the character setting information, the at least one initial object information, the live streaming material information, or the live streaming tool information, wherein the live streaming content planning information indicates that the first script segment comprises at least one of an introduction text for the object to be presented, a historical case text for the object to be presented, or a guidance text for the object to be presented;
determining a plurality of initial search terms according to the live streaming content planning information; and
determining the at least one target knowledge information according to the plurality of initial search terms and the knowledge base.

7. The method of claim 6, wherein the determining the at least one target knowledge information according to the plurality of initial search terms and the knowledge base comprises:
performing N rounds of retrieval in the knowledge base according to a plurality of first-level search terms to obtain the at least one target knowledge information, wherein N is an integer greater than or equal to 1, and the first-level search terms are determined according to the initial search terms.

8. The method of claim 7, wherein the performing N rounds of retrieval in the knowledge base comprises:
determining an n^{th}-level retrieval result in the knowledge base according to a plurality of n^{th}-level search terms; and
determining a plurality of (n+1)^{th}-level search terms according to the n^{th}-level retrieval result and the plurality of n^{th}-level search terms, wherein the at least one target knowledge information is determined according to an N^{th}-level retrieval result, and n is an integer greater than or equal to 1 and less than N.

9. The method of claim 2, wherein the determining the live streaming script according to the at least one first script segment comprises:
determining the first script segment as a live streaming script segment of the live streaming script, in response to determining that a difference between the first script segment and the character setting information is less than a predetermined difference threshold;
determining a first adjusted script segment as the live streaming script segment of the live streaming script, in response to determining that the difference between the first script segment and the character setting information is greater than or equal to the predetermined difference threshold, wherein the first adjusted script segment is obtained by adjusting the first script segment.

10. The method of claim 2, wherein the first video segment comprises at least one predetermined insertion position, and the method further comprises:
determining, in response to receiving a task trigger signal for the first video segment, a task type for the task trigger signal according to a presentation state information of the first video segment; and
generating a second script segment for the task trigger signal according to the task type and a target insertion position among the at least one predetermined insertion position, wherein the second script segment comprises at least one of a task content text or a content connection text, the content connection text is generated according to context data at the target insertion position, and the second script segment is used to generate a second video segment inserted at the target insertion position.

11. The method of claim 10, wherein the second script segment indicates generating the second video segment inserted at the target insertion position by:
generating the second video segment according to the second script segment, in response to determining that a difference between the second script segment and the character setting information is less than a predetermined difference threshold; and
generating the second video segment according to a second adjusted script segment, in response to determining that the difference between the second script segment and the character setting information is greater than or equal to the predetermined difference threshold, wherein the second adjusted script segment is obtained by adjusting the second script segment.

12. The method of claim 10, wherein the presentation state information comprises at least one of a playback progress information of the first video segment or a task execution progress information for the first video segment, the first video segment comprises a plurality of video sub-segments respectively corresponding to a plurality of importance index values, the playback progress information indicates respective playback states of the plurality of video sub-segments, the task execution progress information indicates an execution progress of a prior task for the first video segment, and the prior task is a task executed before receipt of the task trigger signal; and
wherein the determining a task type for the task trigger signal according to a presentation state information of the first video segment comprises:
in response to determining that a target video sub-segment has been played and the prior task has been executed, determining the task type for the task trigger signal, wherein the target video sub-segment is a video sub-segment with an importance index value greater than or equal to a predetermined importance index threshold.

13. The method of claim 10, wherein a plurality of predetermined insertion positions are provided, and the plurality of predetermined insertion positions respectively correspond to a plurality of insertable time instants in the first video segment; and
wherein the generating a second script segment for the task trigger signal according to the task type and a target insertion position among the at least one predetermined insertion position comprises:
determining a plurality of time offset values according to the plurality of insertable time instants and a task trigger time instant at which the task trigger signal is received;
determining the target insertion position from the plurality of predetermined insertion positions according to the plurality of time offset values; and
generating the second script segment for the task trigger signal according to the task type and the target insertion position.

14. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
generate at least one first script segment according to an initial input information, wherein the first script segment comprises a speech content text and an object description sub-segment for a live streaming object, the object description sub-segment comprises an object description text for describing at least one of an action presented by the live streaming object or a presentation mode for the speech content text; and
determine the live streaming script according to the at least one first script segment.

15. The electronic device of claim 14, wherein at least one live streaming object is provided, the at least one live streaming object comprises at least one of a virtual character or an object to be presented, the initial input information comprises at least one of a character setting information for the virtual character, an initial object information for the object to be presented, a live streaming material information, or a live streaming tool information; and
wherein the live streaming script is used to generate a live streaming video, and the live streaming video comprises a first video segment corresponding to the first script segment.

16. The electronic device of claim 15, wherein the object description sub-segment is embedded in the speech content text, the object description sub-segment further comprises at least one of a presentation indicator, a sub-segment start delimiter, a sub-segment end delimiter, or a separator, and the separator is located between the presentation indicator and the object description text.

17. The electronic device of claim 16, wherein the object description sub-segment comprises one of an object presentation-mode description sub-segment, an object action description sub-segment, or an object expression description sub-segment, the object presentation-mode description sub-segment comprises an object presentation-mode description text, the object action description sub-segment comprises an object action description text, and the object expression description sub-segment comprises an object expression description text;
wherein audio data for the speech content text in the first video segment is generated according to a presentation mode described by the object presentation-mode description text; and
wherein image data for the virtual character in the first video segment is generated according to at least one of the object action description text or the object expression description text, the object action description text describes at least one body action of the virtual character, the at least one body action comprises at least one first body action for the object to be presented, and the object expression description text describes at least one facial action of the virtual character.

18. The electronic device of claim 15, wherein the instructions are further configured to cause the at least one processor to at least:
determine at least one target knowledge information according to a knowledge base and at least one of the character setting information, the at least one initial object information, the live streaming material information, or the live streaming tool information; and
generate the at least one first script segment according to the at least one target knowledge information.

19. The electronic device of claim 18, wherein the instructions are further configured to cause the at least one processor to at least:
determine a live streaming content planning information according to at least one of the character setting information, the at least one initial object information, the live streaming material information, or the live streaming tool information, wherein the live streaming content planning information indicates that the first script segment comprises at least one of an introduction text for the object to be presented, a historical case text for the object to be presented, or a guidance text for the object to be presented;
determine a plurality of initial search terms according to the live streaming content planning information; and
determine the at least one target knowledge information according to the plurality of initial search terms and the knowledge base.

20. A non-transitory computer-readable storage medium having computer instructions therein, wherein the computer instructions are configured to cause a computer to at least:
generate at least one first script segment according to an initial input information, wherein the first script segment comprises a speech content text and an object description sub-segment for a live streaming object, the object description sub-segment comprises an object description text for describing at least one of an action presented by the live streaming object or a presentation mode for the speech content text; and
determine the live streaming script according to the at least one first script segment.
